(19) United States
(12) Patent Application Publication
(10) Pub. No.: US 2026/0073186 A1
(43) Pub. Date: Mar. 12, 2026

(54) DEEP LEARNING MODELS FOR GEOFEATURE DISCOVERY

(71) Applicant: Schlumberger Technology Corporation, Sugar Land, TX (US)

(72) Inventors: Hiren Maniar, Houston, TX (US); Atul Laxman Katole, Houston, TX (US)

(21) Appl. No.: 19/323,567

(22) Filed: Sep. 9, 2025

Related U.S. Application Data
(60) Provisional application No. 63/693,405, filed on Sep. 11, 2024.

(51) Int. Cl. G06N 3/042; G06N 3/096

(52) U.S. Cl. CPC G06N 3/042; G06N 3/096

(57) ABSTRACT

A method for discovering geofeatures in a subterranean formation includes receiving first input data including training seismic surveys. The method also includes training a model based on the training seismic surveys to produce a pre-trained model using a self-supervised learning (SSL) technique. The method further includes receiving second input data. The second input data includes one or more target seismic surveys associated with the subterranean formation. The method also includes generating geological representations of the subterranean formation using the pre-trained model and based on the one or more target seismic surveys. The method also includes generating a database based on the geological representations. The method also includes generating an output based on the database.

### CROSS-REFERENCE TO RELATED APPLICATIONS

This application claims priority to and the benefit of U.S. Provisional Patent Application No. 63/693,405 filed on Sep. 11, 2024, the entirety of which is incorporated herein by reference to the extent consistent with the present disclosure.

### BACKGROUND

Vision transformer (ViT) based architectures have evolved to complex models that can meaningfully process large volumes of seismic data. Various means for self-supervised learning (e.g., using unlabeled data) may permit unsupervised training of these models on large data corpuses. Models built in such a fashion, so-called “pretrained models,” can exhibit feature representations which are more “complete,” allowing for better generalization, and allow for rich domain-specific semantic representations. The pretrained network features capture both relative positional as well as semantic aspects of seismic data and can be used to search and discover geofeatures of interest. They may also be used to repurpose for downstream seismic interpretation or be employed in a new relatively lightweight network to do so. One reason why this is possible is that a well-trained pretrained network offers a rich feature space, and the generalizes well. Thus, if the pretrained model generalizes well, for new seismic datasets, the model may be directly applied (e.g., in an inference mode) to extract the meaningful features.

It is worth drawing a distinction between the term's “features” and “geofeatures.” Use of the stand-alone term “features” refers to the representations in the deep network's latent space and may or may not have explicit or direct relevance to geophysical characteristics, as an expert seismic interpreter would judge by. However, these “features” may be efficiently used to semantically construct “geofeatures” as an expert would envision. Thus, “geofeatures” refer to seismic features (e.g., structural, textural, etc.) as an expert seismic interpreter would view them, while “features” refers to a mathematical decomposition of the same.

What is needed is an improved system and method for generating and using deep learning models for geofeature discovery.

### SUMMARY

A method for discovering geofeatures in a subterranean formation is disclosed. The method includes receiving first input data. The first input data includes training seismic surveys. The method also includes training a model based on the training seismic surveys to produce a pre-trained model using a self-supervised learning (SSL) technique. The method further includes receiving second input data. The second input data includes one or more target seismic surveys associated with the subterranean formation. The method also includes generating geological representations of the subterranean formation using the pre-trained model and based on the one or more target seismic surveys. The method also includes generating a database based on the geological representations. The method also includes generating an output based on the database.

A computing system is also disclosed. The computing system includes one or more processors and a method system. The method system includes one or more non-transitory computer-readable media storing instructions that, when executed by at least one of the one or more processors, cause the computing system to perform operations for discovering geofeatures in a subterranean formation. The operations include receiving first input data including training seismic surveys. The training seismic surveys include one or more examples of the geofeatures. The operations also include training a model based on the training seismic surveys to produce a pre-trained model using a self-supervised learning (SSL) technique. The model is a Vision Transformer (ViT) model. The SSL technique includes a self-distillation with no labels technique. The operations also include receiving second input data including one or more target seismic surveys associated with the subterranean formation. The operations further include generating geological representations of the subterranean formation using the pre-trained model and based on the one or more target seismic surveys. Generating the geological representations includes generating seismic sections based on the one or more target seismic surveys. Generating the geological representations also includes generating the geological representations based on the seismic sections using the pre-trained model. The operations also include generating a database based on the geological representations. The operations also include generating an output based on the database.

A non-transitory computer-readable medium is also disclosed. The medium stores instructions that, when executed by one or more processors of a computing system, cause the computing system to perform operations for discovering geofeatures in a subterranean formation. The operations include receiving first input data including training seismic surveys. The training seismic surveys include one or more examples of the geofeatures. The training seismic surveys do not include one or more labels, ground-truth annotations, or a combination thereof. The operations also include training a model based on the training seismic surveys to produce a pre-trained model using a self-supervised learning (SSL) technique. The model is a Vision Transformer (ViT) model. The SSL technique includes a self-distillation with no labels technique. The pre-trained model is a large foundation model. The operations also include receiving second input data including one or more target seismic surveys associated with the subterranean formation. The operations also include generating geological representations using the pre-trained model and based on the one or more target seismic surveys. Generating the geological representations includes generating seismic sections based on the one or more target seismic surveys. Generating the geological representations also includes transforming the seismic sections to the geological representations using the pre-trained model. The geological representations are high-dimensional vectors. The operations also include generating a database based on the geological representations. The operations also include generating an output based on the database.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates an exemplary workflow for training a model, according to an embodiment.

FIG. 3 illustrates an example of GeoFeatureFM, according to an embodiment.

FIG. 4 illustrates an exemplary workflow for discovering seismic geological features in a subterranean formation, according to an embodiment.

FIG. 5A illustrates GeoFeatureFM foundation model training with unsupervised tasks and hundreds of datasets, and FIG. 5B illustrates GeoFeatureFM downstream task training for segmentation with handful of labels, according to an embodiment.

FIGS. 6A-6C illustrate structural, stratigraphic, and depositional features discovered by GeoFeatureFM, according to an embodiment.

FIGS. 7A and 7B illustrate images showing the performance of the model for multi-class segmentation of turbidites, according to an embodiment.

FIG. 8 illustrates an exemplary workflow for extracting high-dimensional geological features from a seismic section input, according to an embodiment.

FIG. 9 illustrates a flowchart of a method for discovering geofeatures in a subterranean formation, according to an embodiment.

FIG. 10 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

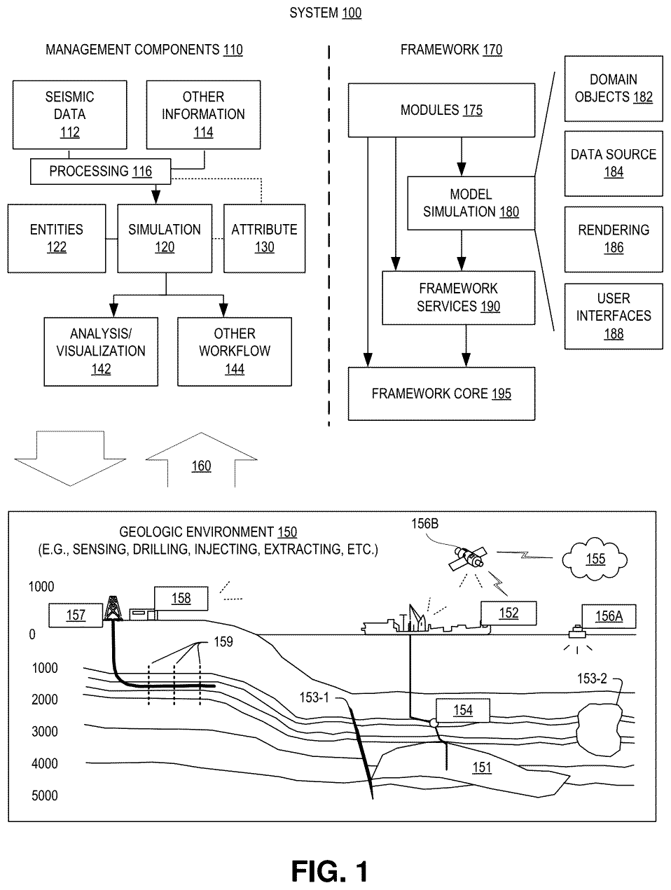

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT®.NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

As an example, the simulation component 120 may include one or more features of a simulator such as SYMMETRY™ software (SLB, Houston, Texas). More particularly, SYMMETRY™ may process workflows in a single integrated environment with accurate thermodynamic fluid representation and consistent modeling across multiple disciplines including process, production, and HSE. The simulator integrates steady-state and transient (e.g., dynamic) analyses that may be tailored for each domain. This approach enables users to optimize processes in upstream, midstream, and downstream sectors while maximizing profits and minimizing capital expenditures. It may also help reduce emissions, energy consumption, and waste.

As an example, the simulation component 120 may include one or more features of a simulator such as PIPESIM™ (SLB, Houston, Texas). More particularly, PIPESIM™ is steady-state multiphase flow simulator that incorporates the three areas of flow modeling: multiphase flow, heat transfer and fluid behavior.

As an example, the simulation component 120 may include one or more features of a simulator such as OLGA™ (SLB, Houston, Texas). More particularly, OLGA™ is a dynamic multiphase flow simulator that models transient flow (e.g., time-dependent behaviors) to maximize production potential. Transient modeling is a component for feasibility studies and field development design. Dynamic simulation is useful in deep water and is used in both offshore and onshore developments to investigate transient behavior in pipelines and wellbores. Transient simulation with the OLGA™ simulator provides an added dimension to steady-state analysis by predicting system dynamics, such as time-varying changes in flow rates, fluid compositions, temperature, solids deposition, and operational changes.

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

The present disclosure utilizes a Vision Transformer (ViT) based architecture to process relatively large volumes of seismic data. The ViT based architecture may treat image patches as sequences of tokens and apply a transformer-based approach to vision modality that was originally developed to model the sequential nature of symbols occurring in natural language. Various means for self-supervised learning, such as using unlabeled data only, permit unsupervised training of these models on the relatively large volumes of seismic data. Models built may be referred to as pre-trained models and can exhibit feature representations that are more “complete,” allowing for improved generalization and rich domain-specific semantic representations. The pre-trained models can capture both positional as well as semantic aspects of the seismic data and can profitably be used to search and discover geofeatures or seismic geological features in a subterranean formation.

### Self-Supervised Training of a Model

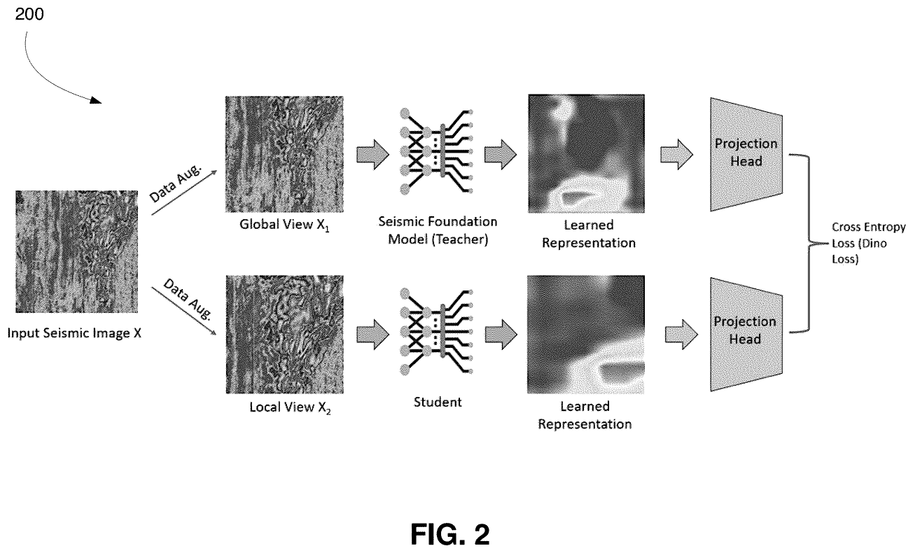

FIG. 2 illustrates an exemplary workflow 200 for training a model, according to an embodiment. Generally, a self-supervised learning approach based on knowledge-distillation techniques may be utilized to train a model, such as the ViT model, for seismic domains. The self-supervised learning approach may be or include, but is not limited to, distillation with no labels (DINO). This may be a self-supervised training approach that do not utilize labeled datasets for training. As illustrated in FIG. 2, the workflow may include training a student network to closely match an output distribution of a teacher network. For example, for each seismic image or patch utilized for training, a global view and a local view may be created using data augmentation techniques. The local views may be presented to the student network and the global views may be presented to the teacher network. Given a fixed teacher network, the student network may learn to match the teacher network distributions by minimizing the cross-entropy loss between the distributions. At the end of training the model (e.g., the VIT model), the learned weights of the teacher network may be utilized as or for the pre-trained model for geofeature discovery and base models for geobody segmentation.

### Deep Learning Models for Geofeature Discovery and Other Interpretation Tasks

A deep neural network trained in a careful, nuanced manner provides a pretrained model, and can provide features which can be robustly used for geofeature discovery and/or exploration and various interpretation tasks. Examples of such tasks include discovery of shallow hazards, hot spot determination, and numerous other geofeatures such as: foresets (e.g., turbidites), volcanics, etc. Furthermore, these features may be employed to quickly re-purpose or build a relatively lightweight network of seismic interpretation tasks such as facies classification, salt detection, fault detection, etc. In the latter case, in comparison to fully supervised machine-learning methods, using a rich feature set as a starting point can provide a quicker turnaround, and involves far fewer labels from the expert. Thus, features from such pretrained models can be repeatedly used as a starting point for various downstream applications by quickly repurposing them, using very few labels.

A pretrained model may be built using seismic data such that, after training, the pretrained model is endowed with a rich set of features. Thus, the network design, the network training paradigm, and the problem formulation come together to enable applications which tackle some difficult seismic problems from geofeature discovery and exploration to downstream seismic interpretation tasks. The modeling may be referred to as GeoFeatureFM.

### GeoFeatureFM Foundation Model

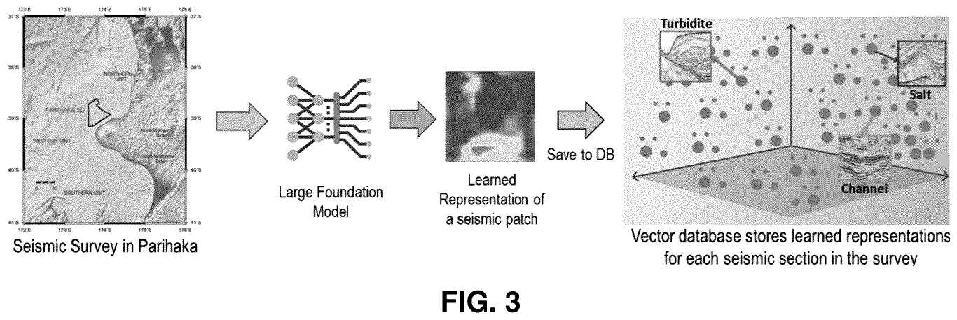

FIG. 3 illustrates an example of GeoFeatureFM, according to an embodiment. A large foundation model, such as the pre-trained model, may be employed to project each survey to a geological meaningful representation. A seismic database may be a three-dimensional (3D) snapshot or representation of the earth's subsurface or a subterranean formation in a particular basin and/or geography. The seismic database may be sliced vertically to create a plurality of seismic patches and/or seismic tiles. These seismic patches and/or seismic tiles may be treated as images and utilized to train a ViT architecture-based model for a seismic domain or for generating a database, such as a vector database, as illustrated in FIG. 3. The vector database may store higher dimensional seismic representations as high-dimensional vectors to thereby enable fast and scalable semantic similarity searches, as illustrated in FIG. 3. As further illustrated in FIG. 3, the vectors may be organized into the high-dimensional space, such as a multi-dimensional domain, where similar seismic geological structures (e.g., turbidites, salt, channels, etc.) may be clustered together. The multi-dimensional domain (e.g., 3D domain and/or plot) may allow or enable efficient discovery and retrieval of conceptually similar geofeatures or geological features. The discovery and/or retrieval of the geofeatures may be conducted in a matter of seconds (e.g., about 1-2 seconds) by utilizing the vector database.

### Geofeature Discovery

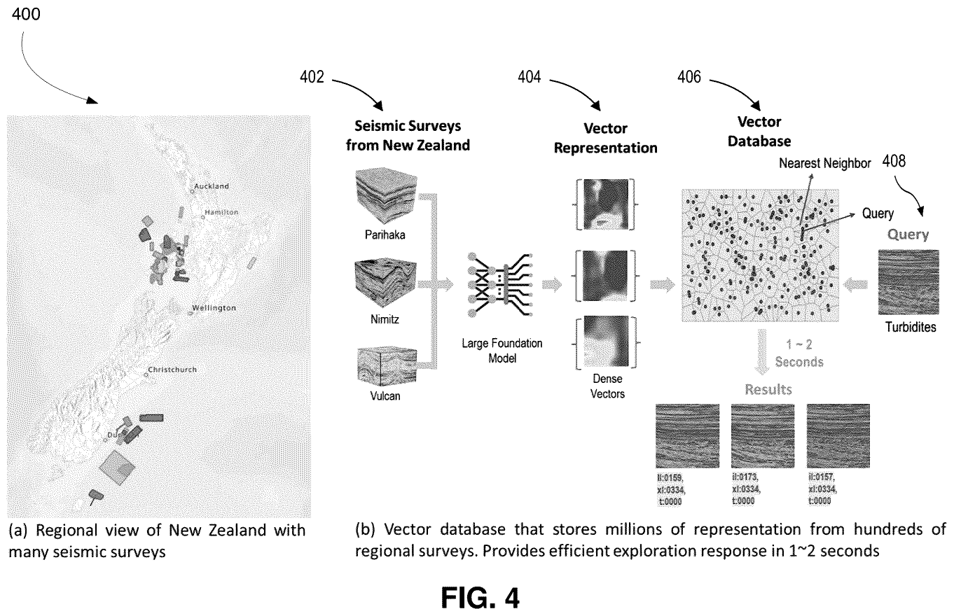

FIG. 4 illustrates an exemplary workflow 400 for discovering seismic geological features in a subterranean formation, according to an embodiment. As illustrated in FIG. 4, one or more target seismic surveys of a particular basin/geography, such as New Zealand, may be utilized to generate a vector database using the pre-trained model (e.g., the large foundation model). The target seismic survey may include one or more geofeatures of interest or seismic geological features of interest. The seismic surveys may be utilized to generate the vector database using the pre-trained model, as previously discussed with reference to FIG. 3. The workflow 400 may include receiving a query, such as a seismic geological feature query or a geofeature query including a seismic geological feature or geofeature of interest. Geofeature discovery may include utilizing one or more analogs, or reference seismic images for geological features, of the vector database to identify and search for the geofeature of interest. The geological features may be or include, but are not limited to, one or more of fans, channels, turbidites, geological bodies such as salts and faults, etc., or the like, or any combination thereof. The pre-trained model may generate the vector database and utilize the vector database as a reference library of reference images for each of the geological features. A user may provide a input query, such as a seismic geological feature query, for a target geofeature or a geofeature of interest. Analogs may be utilized in the database (e.g., reference library) to search for the geofeature of interest and provide an output or results. The results may include the geofeature of interest as well as a respective location of the geofeature of interest.

The system and methods disclosed herein may provide or permit a user (e.g., domain expert) to explore major geofeatures automatically in a single survey or multitude of contiguous region-wide surveys (e.g., 100s of surveys) in a matter of seconds. The system and methods may utilize pre-trained models or large foundation models to learn multi-scale features and in-turn characterize geofeatures (FIG. 3). To facilitate the exploration of major geofeatures, the learned multi-scale dense features from multitudes of contiguous region-wide surveys may be stored in the vector database. It should be appreciated that there the geofeatures indexed in the vector database may be indexed by any suitable criteria that permits quick similarity searches, and the criteria may depend, at least in part, by a desired speed and/or accuracy of the search. Illustrative indexing criteria may be or include, but are not limited to, one or more of a semantic similarity search, approximate nearest neighbors (ANN), analogs, or a combination thereof.

### GeoFeatureFM Foundation Model Training

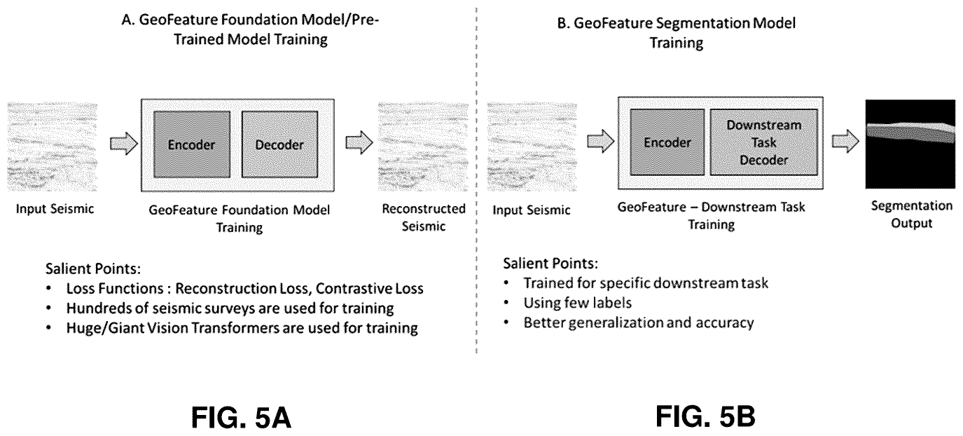

FIG. 5A illustrates GeoFeatureFM foundation model training with unsupervised tasks and hundreds of datasets, according to an embodiment. While FIG. 5A suggests reconstruction loss, it should be understood that self-learning methodologies may also be applied. The decoder may or may not be employed for downstream tasks. FIG. 5B illustrates GeoFeatureFM downstream task training for segmentation with handful of labels, according to an embodiment. The encoder features may be frozen, but may optionally be slightly fine-tuned on new datasets.

The types of applications possible are closely related to the feature set that the pretrained model offers. For instance, if the application is a geobody classification problem, large scale features may suffice. However, if a semantic segmentation of geobodies or discovery of shallow hazards or hot spots is involved, the pretrained machine feature set may involve pixel-level capture too. Thus, if a deep network is built carefully to capture a range of coarse to fine-grained nuances (effectively multi-scale capture), it can be employed in a versatile fashion. Multi-scale capture is a tall order. Transformer- or hybrid-transformer models excel at it (hybrid implies a design incorporating transformers as well as convolutional elements). However, the architecture of the model by itself may not be sufficient to ensure a rich, semantically meaningful feature set to accomplish a spectrum of tasks. How the model is trained can have a strong bearing on the nature of features constructed, and in turn, its impact on downstream applications. Thus, the method may employ a self-supervised approach with a strong focus on self-distillation learning methods. Thus, the method may innovate on several fronts: the network architecture, the self-supervised training methodology, and the problem formulation.

Part of the problem formulation during the geofeature discovery is the use of one or more analogs (“references” or “reference library”). These together allow the method to robustly discover geofeatures (a functionality never seen to date), and tackle problems which are otherwise quite formidable when conducted with conventional machine-learning methods.

### Discovered Features

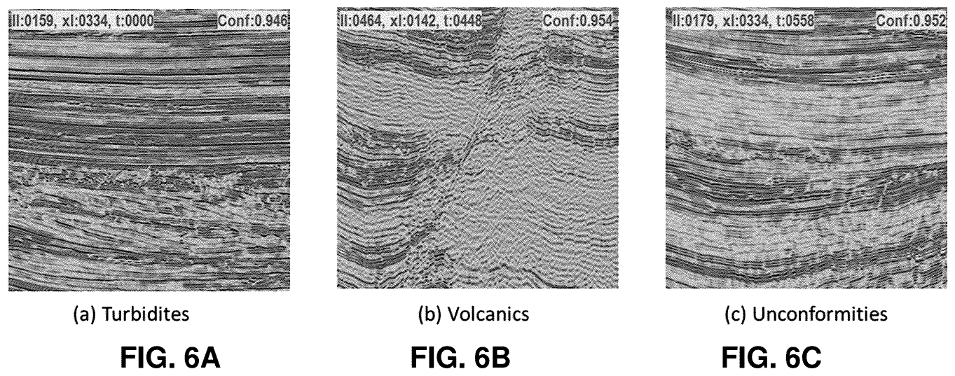

For a single survey or multitudes of contiguous region-wide surveys (e.g., 100s of surveys), in a matter of seconds, the method may permit a user to explore major geofeatures automatically discovered by GeoFeatureFM. The method employs large foundation models (FMs) to learn multi-scale features and in turn characterize geofeatures. FIGS. 6A-4C illustrate structural, stratigraphic, and depositional features discovered by GeoFeatureFM, according to an embodiment. More particularly, FIG. 6A illustrates turbidites, FIG. 6B illustrates volcanics, and FIG. 6C illustrates unconformities. To facilitate the exploration of major geofeatures in a matter of seconds, the learnt multi-scale dense features from multitudes of contiguous region-wide surveys may be stored in a Vector Database (DB). There are various means to index these features (by various criteria) to permit for quick similarity search, and the exact choice of index is a balance between search speed and accuracy of search. Currently, the method enables a geofeature search operation using Approximate Nearest Neighbors (ANN), and using analogs that can be discovered features in a matter of seconds.

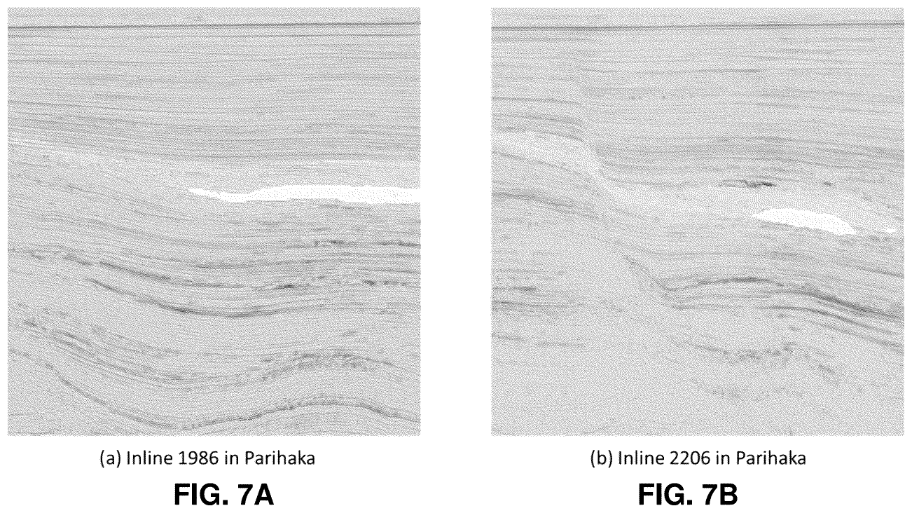

The method equips a pretrained machine with a relatively light-weight segmentation head, and quickly fine-tunes the head using very few multi-class segmentation labels. FIGS. 7A and 7B illustrate images showing the performance of the model for multi-class segmentation of turbidites, according to an embodiment. More particularly, they illustrate an example of a downstream interpretation task using features from the foundation model. Segmentation results for inline sections 1986 and 2206 are displayed where the extracted foresets are overlayed with colors.

### Rapid Seismic Interpretation

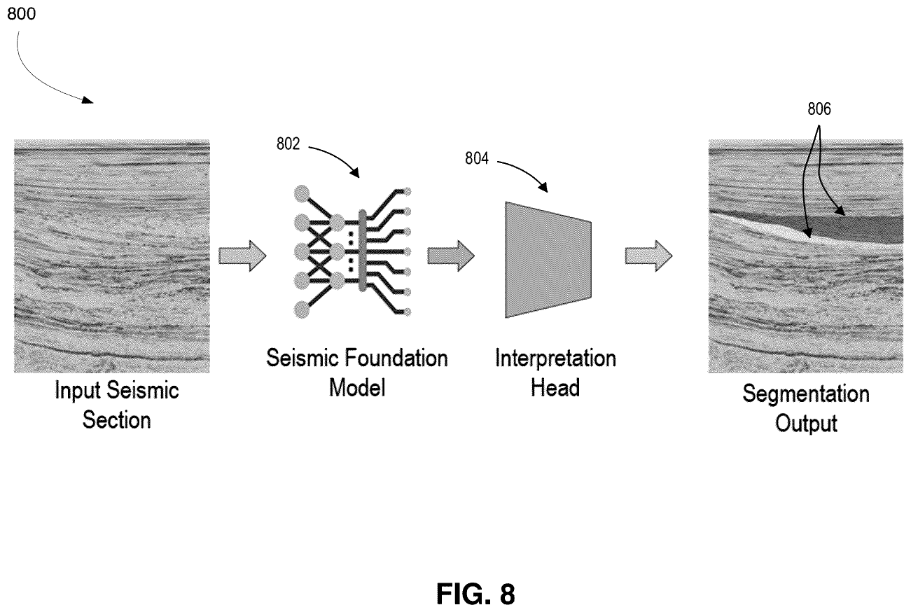

FIG. 8 illustrates an exemplary workflow 800 for extracting high-dimensional geological features from a seismic section input, according to an embodiment. The systems and methods disclosed herein may be utilized to train a seismic interpretation model for one or more downstream tasks using the pre-trained model or the pre-trained seismic foundation model and one or more labels. The seismic interpretation model may be a small model. The small model may be a convolution neural network. The pre-trained model may be equipped with a relatively light-weight segmentation head. The segmentation head may be fine-tuned or trained using the one or more labels, which may be multi-class segmentation labels. The segmentation head may be used to segment the geobodies, such as salt, faults, horizons, etc. It should be appreciated that the workflow 800 may utilize a relatively small amount of labels to train the interpretation head, and the training may be relatively short (e.g., <1 hour), as the pre-trained model has learned to extract rich feature sets from the seismic images. In one example, the interpretation head may be trained with labeled training datasets. The number of labeled training datasets may be less than 20, less than 10, less than 5, or less.

### Example Method

The method may include receiving seismic data. In other words, seismic data may input into a model. The method may also include architecting and training the model, as described below. The trained machine may generalize well. The trained model captures the vast majority of the seismic features. As discussed above, “features” are mathematical representations in the latent space of a trained model, while “geofeatures” are directly observed by the expert in the seismic data. The features capture the semantic nuances of the seismic data. The features may be dense vector representations. The features may collectively constitute the latent space. Learning such features is often called representation learning.

Given the seismic data, the model effectively projects the seismic data to the latent space. There may be infinite ways to project the seismic data onto latent spaces, and different model constructs and training paradigms may provide different latent spaces (i.e., features).

As part of the model architecture, the family of models may be viewed as transformers or as hybrid transformers. On abstraction, from a standpoint of information flow within the network, the transformer architecture is like vision transformers with various changes. Hybrid transformers employ convolutional constructs deeper within the network. Of note are changes in the early convolutional layers which tokenize the input. These constructs ensure that short scale information within the inputs is not unduly filtered out. Other changes include the total number of multiple self-attention (MSA) heads employed. Overall, by design, this transformer-based method is endowed to capture multi-scale seismic attributes. By deep stacking the MSAs, the method may capture semantic nuances, along with large context. The model input may be both 2D as well as 3D sections of the seismic input, and the choice is determined by the geofeature. For example, to capture subtle nuances of geological fans and channels, the method may employ 3D inputs.

As part of the model training, various self-supervised training methodologies may be employed to build a pretrained model and each effectively constraints the under-constrained transformer model. Depending on the self-learning methodology adopted, latent spaces with different properties may arise. The method favors a self-distillation approach for self-learning. To allow for multi-scale characterization, the method uses large seismic section inputs. The method trains the model using numerous seismic surveys to ensure diversity and complexity of seismic data is well captured and to allow the model to generalize well. Various data augmentation techniques may be employed during training.

At this point, the method has architected the model and trained it (e.g., in special ways) so as to provide a rich set of features. The model and/or features can be used for a “semantic search” within the seismic data/surveys (this as opposed to “literal search”). This search may be conducted in latent space, as opposed to directly, in the original space of the seismic data itself.

A first application may be or include a geobody and/or geofeature search. What if the model is provided with a single image of a geobody of interest? This can be an image of a volcanic, turbidite section, “hot spot,” unconformities, etc. These have very specific geological meaning/constructs. Then, the model may project this image to the latent space, and then against the entire seismic survey it has already projected onto the latent space. The model may then run a “similarity search” for geobodies and/or geofeatures. Here, the expert user provides the input image to search.

A second application may be or include an automated geobody discovery. Instead of the user providing an image of a geobody or geological construct, what if the user internally stores exemplars of the geofeatures of interest? Let's say internally there is a library or collection of such geofeatures. With every new seismic the user encounters, the method may execute the first application against each image in the internal collection of geofeatures, and thus “discover automatically” the interesting geofeatures of interest. Here the use of the terms automated and automatic means that no input is received from the user.

The above applications may be conducted in a robust fashion because of the rich semantically meaningful feature set that the model has created. There may also be a case where each seismic survey or dataset can be projected onto the latent space. In this case, each feature may be stored in a vector database. In such instances, any image to be searched may be first projected onto the latent space, and then the features may be searched in the vector database. This allows the user to search through 100s of surveys in a matter of few seconds.

Storing features in a vector database involves indexing the features. As the method is interested in similarities, there are various ways to index to permit the similarity search. For example, the method may employ an approximate nearest neighbor for indexing.

Above, the method focused on using features to build a geofeature search and automatic geofeature discovery system. Here, the method focuses on additional uses of rich features to conduct numerous downstream seismic interpretation tasks.

A third application may be or include downstream interpretation tasks. The method may use the features as input to a new model to accomplish various additional seismic interpretation tasks. Examples may include horizon picking, faults, facies classification, etc. Downstream interpretation may be conducted using features. More particularly, given new seismic data, and a specific downstream interpretation task (e.g., segmentation), the method may first project the given seismic data to the latent space so that the feature(s) therein can be further used. The method in the first application provides the user with a few search hits of turbidites. The method then asks the expert user to precisely label a few examples of turbidites (e.g., in the original seismic space) within these examples. The method then builds a lightweight neural network model and trains it. For example, the input may be the features from the latent space corresponding to the expert labelled data, and the output may be the expert labelled data. Once such a model is trained, it may be applied to the entire survey to “segment turbidites.”

Because the feature set is rich, the method may use a lightweight model for segmentation purposes. In addition, because the features capture semantic nuances of the seismic data, the method may use a few labels to segment complex geofeatures such as turbidites. This approach lessens the burden on the expert because a few labels are used. As the method also uses a lightweight model for downstream tasks, the training time is small (e.g., compared to a fully trained machine from scratch). Above the method used one example of a downstream task; however, the method may be applied to numerous other seismic interpretation tasks.

### Example Method

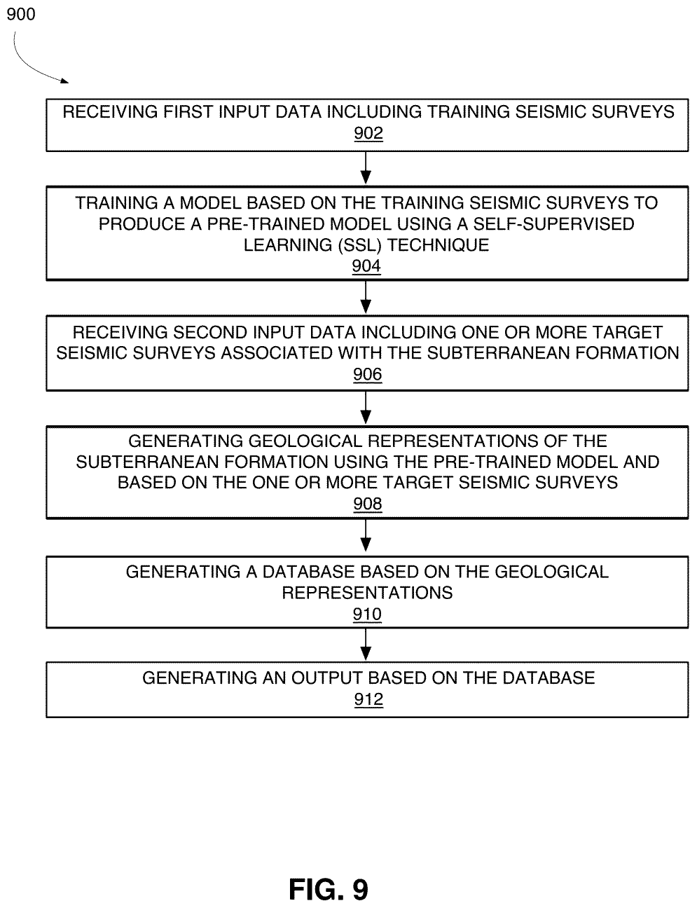

FIG. 9 illustrates a flowchart of a method 900 for discovering geofeatures in a subterranean formation, according to an embodiment. An illustrative order of the method 900 is provided below; however, one or more portions of the method 900 may be performed in a different order, simultaneously, repeated, or omitted. At least a portion of the method 900 may be performed using a computing system.

The method 900 may include receiving first input data including training seismic surveys, as at 902. The training seismic surveys may include training datasets. The training datasets may include real training datasets, synthetic training datasets, or a combination thereof. The training datasets may include one or more examples of seismic geological features (“geofeatures”). The geofeatures may be or include, but are not limited to, one or more of a turbidite, a volcanic, a fan, a channel, a shallow hazard, a hot spot, salt, a foreset, an unconformity, a fault, a horizon, or the like, or a combination thereof. In at least one embodiment, the training seismic surveys do not include one or more of labels, ground-truth annotations, or a combination thereof.

The method 900 may also include training a model based on the training seismic surveys to produce a pre-trained model using a self-supervised learning (SSL) technique, as at 904. The pre-trained model may be a large foundation model. The model may include a Vision Transformer (ViT) model. The SSL technique may be based on one or more knowledge-distillation techniques. The one or more knowledge-distillation techniques may include a self-distillation with no labels technique. The self-distillation with no labels technique may be or include, but is not limited to, distillation with no labels (DINO). The pre-trained model may be configured to identify the one or more examples of the seismic geological features, a respective location or position of the seismic geological features, or a combination thereof.

In at least one embodiment, illustrated in FIG. 2, training the model based on the training seismic surveys may include augmenting the training seismic surveys to generate augmented global views and augmented local views using data augmentation techniques of the SSL technique. Training the model include producing teacher representation/embeddings with a teacher network of the SSL technique based on the augmented global views. Training the model may also include producing student representation/embeddings with a student network of the SSL technique based on the augmented local views. Training the model may further include determining student weights of the student network based on the student embeddings and the teacher embeddings. Training the model may also include determining teacher weights of the teacher network based on the student weights. Training the model may also include producing the pre-trained model based on the teacher weights.

The method 900 may also include receiving second input data comprising one or more target seismic surveys associated with the subterranean formation, as at 906. FIG. 4 illustrates the target seismic surveys 402 associated with the subterranean formation (e.g., New Zealand). The one or more target seismic surveys may include one or more seismic geological features of interest or geofeatures of interest. The one or more target seismic surveys may include real datasets. The one or more target seismic surveys may be respective 3D representations of the subterranean formation. The second input data may be different than the first input data. The one or more seismic geological features of interest may be or include, but are not limited to, one or more of a turbidite, a volcanic, a fan, a channel, a shallow hazard, a hot spot, salt, a foreset, an unconformity, a fault, a horizon, or the like, or a combination thereof.

The method 900 may further include generating geological representations of the subterranean formation using the pre-trained model and based on the one or more target seismic surveys, as at 908. FIG. 4 illustrates the geological representations 404 generated using the pre-trained model (e.g., the large foundation model) and based on the one or more target seismic surveys 402. Generating the respective geological representations 404 may include generating seismic sections based on the target seismic survey 402. The seismic sections may include one or more of seismic patches, seismic tiles, seismic images, a 2-dimensional representative portion of the target seismic survey, or a combination thereof. Generating the respective geological representations may also include generating the respective geological representations 402 based on the seismic sections using the pre-trained model. The geological representations 402 may be or include a projection of the respective seismic sections. Generating the respective geological representations 402 may also include transforming the seismic sections to high-dimensional vectors using the pre-trained model. In at least one embodiment, the geological representations 402 may be high-dimensional vectors. In at least one example, each high-dimensional vector of the high-dimensional vectors may include a semantic meaning.

The method 900 may also include generating a database based on the geological representations 404, as at 910. An exemplary representation of the database 406 is illustrated in FIG. 4. The database 406 may be indexed based on one or more similarity measures.

In at least one embodiment, generating the database 406 may include storing the geological representations in the database. Generating the database 406 may also include plotting the high-dimensional vectors or the geological representations 404 in a multi-dimensional domain of the database 406. Each of the high-dimensional vectors may include a respective semantic meaning. Generating the database 406 may also include clustering each of the high-dimensional vectors in the multi-dimensional domain based on the respective semantic meaning.

In at least one embodiment, generating the database 910 may include training a small model to produce an interpretation head downstream of the pre-trained model. FIG. 8 illustrates an exemplary workflow 800 of the interpretation head 804 downstream of the pre-trained model 802 (e.g., seismic foundation model). The small model may be a convolutional neural network. Training the small model may include receiving labeled training datasets, and training the small model based on the labeled training dataset to produce the interpretation head 804. The labeled training datasets may include one or more examples of labeled seismic geofeatures. The number of the one or more examples of the labeled seismic geofeatures may be less than 20, less than 10, less than 5, or less. In at least one example, training the small model includes a stochastic gradient descent mechanism. Generating the database 910 may also include segmenting the geofeatures of interest to produce one or more extracted segments 806 using the interpretation head and based on the respective geological representations, as illustrated in FIG. 8. Segmenting the geofeatures of interest may include receiving the high-dimensional vectors at the interpretation head 804 from the pre-trained model 802, as illustrated in FIG. 8. Segmenting the geofeatures of interest using the interpretation head 804 may also include extracting the one or more segments of the geofeatures using the interpretation head to produce the one or more extracted segments 806. In at least one embodiment, a database may be generated based on the one or more extracted segments 806. In at least one embodiment, the method 900 may include generating segmentation masks using the interpretation head 804 and based on the one or more extracted segments 806, and generating the output 912 based on the segmentation masks. The one or more segmentation masks may be displayed as overlays on the target seismic surveys. The segmentation masks may represent the one or more segments, the respective location of the geofeatures, the respective type of the geofeatures, or a combination thereof.

The method 900 may also include generating an output based on the database, as at 912. The method 900 may further include displaying the output from the database. The method 900 may also include performing an action in response to displaying the output. The action may include generating or transmitting a signal that recommends, instructs, or causes a physical action to occur. The physical action may include one or more of optimizing a trajectory of a wellbore drilling operation, conducting drilling operations, conducting an exploratory operation, utilizing the single-upscaled permeability model in a simulation model, designing a production strategy, designing a hydraulic fracturing strategy, conducting risk assessments, or any combination thereof.

In at least one embodiment, the method 900 may include receiving a geofeature query 408 including one or more geofeatures of interest, as illustrated in FIG. 4. The geofeature query 408 may include one or more of an image of the geofeature of interest, test of the geofeature of interest, or a combination thereof. In at least one embodiment, generating the output 912 based on the database 406 may include identifying the one or more geofeatures of interest in the database 406 based on the geofeature query 408. For example, generating the output 912 may include identifying the one or more geofeatures of interest in the database 406 based on the geofeature query 408 using one or more analogs, a semantic similarity search, approximate nearest neighbors (ANN), or a combination thereof. Generating the output based on the database 406 and the geofeature query 408 may be performed or conducted in less than 1 min, less than 30 sec, less than 15 sec, less than 10 sec, less than 5 min, or less, as illustrated in FIG. 4.

In at least one embodiment, the method 900 may include automatically identifying one or more geofeatures of interest in the database based on the geological representations. Automatically identifying the one or more geofeatures of interest may include identifying a respective type of the one or more geofeatures of interest, a respective location of the one or more geofeatures of interest, or a combination thereof. In at least one example, generating a database 910 may include storing the respective type of the one or more geofeatures of interest, the respective location of the one or more geofeatures of interest, or a combination thereof, in the database.

In at least one embodiment, another method for discovering geofeatures in a subterranean formation may include receiving first input data. The first input data may include one or more first seismic surveys. The method may also include training a model based upon the first input data produce a pre-trained model. The pre-trained model may include a large foundation model (FM). The model employs self-attention and convolutional computing elements. An architecture of the model includes constructs to allow for multi-scale information capture. The pre-trained model includes a plurality of features. Training the model includes generating reconstructed seismic data. The reconstructed seismic data is generated using a self-supervised training technique. The self-supervised training technique includes a distillation technique. The distillation technique is a self-distillation technique. The method may also include receiving second input data. The second input data includes one or more second seismic surveys. The second input data is different than the first input data. The method may also include projecting the second input data to a geological representation using the pre-trained model. The geological representation may include a seismic section, a seismic patch, an image of a seismic geofeature, or a thumbnail sketch of the seismic geofeature. The second input data may be employed to conduct a semantic similarity search for new seismic input data. The method may also include identifying the seismic geofeature in the geological representation. The seismic geofeature may be identified by a computing system or a user. The seismic geofeature may include a turbidite, a volcanic, a fan, a channel, a shallow hazard, a hot spot, salt, a foreset, or an unconformity. The method may also include storing the geological representation in a vector database or a system of distributed vector databases. The vector database or the system of distributed vector databases may be indexed based upon one or more similarity measures. The method may also include generating seismic interpretation artifacts using the pre-trained model. The seismic interpretation artifacts may include faults, horizons, or facies. The method may also include displaying the geological representation or the seismic interpretation artifacts. The method may also include performing a wellsite action in response to the geological representation, the seismic geofeature, or the seismic interpretation artifacts. The wellsite action may be or include generating and/or transmitting a signal (e.g., using a computing system) that instructs or causes a physical action to occur at a wellsite. The wellsite action may also or instead include performing the physical action at the wellsite. The physical action may include selecting where to drill a wellbore, drilling the wellbore, varying a weight and/or torque on a drill bit that is drilling the wellbore, varying a drilling trajectory of the wellbore, varying a concentration and/or flow rate of a fluid pumped into the wellbore, or the like.

### Exemplary Computing System

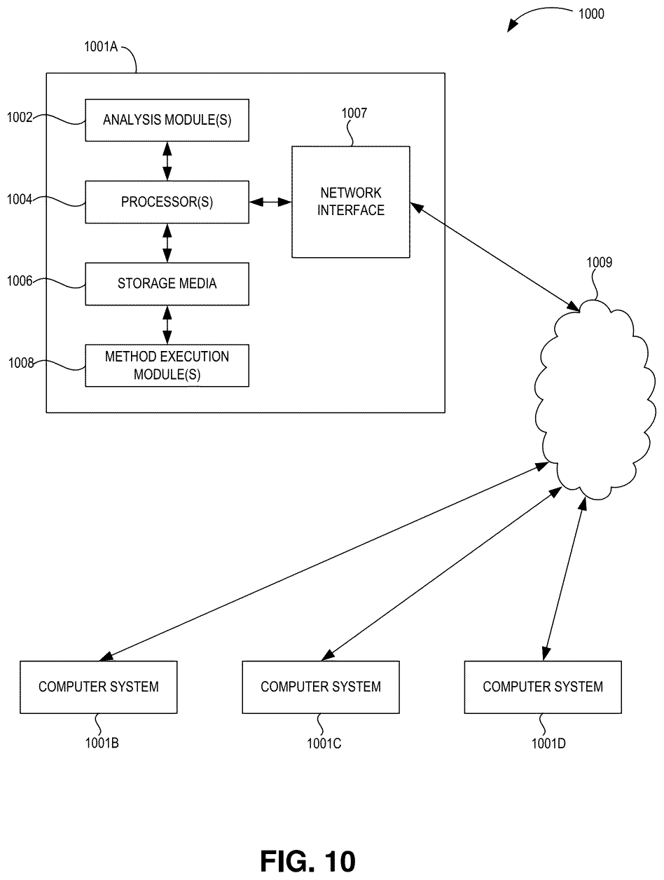

In some embodiments, the methods of the present disclosure may be executed by a computing system. FIG. 10 illustrates an example of such a computing system 1000, in accordance with some embodiments. The computing system 1000 may include a computer or computer system 1001A, which may be an individual computer system 1001A or an arrangement of distributed computer systems. The computer system 1001A includes one or more analysis modules 1002 that are configured to perform various tasks according to some embodiments, such as one or more methods disclosed herein. To perform these various tasks, the analysis module 1002 executes independently, or in coordination with, one or more processors 1004, which is (or are) connected to one or more storage media 1006. The processor(s) 1004 is (or are) also connected to a network interface 1007 to allow the computer system 1001A to communicate over a data network 1009 with one or more additional computer systems and/or computing systems, such as 1001B, 1001C, and/or 1001D (note that computer systems 1001B, 1001C and/or 1001D may or may not share the same architecture as computer system 1001A, and may be located in different physical locations, e.g., computer systems 1001A and 1001B may be located in a processing facility, while in communication with one or more computer systems such as 1001C and/or 1001D that are located in one or more data centers, and/or located in varying countries on different continents).

A processor may include a microprocessor, microcontroller, processor module or subsystem, programmable integrated circuit, programmable gate array, or another control or computing device.

The storage media 1006 may be implemented as one or more computer-readable or machine-readable storage media. Note that while in the example embodiment of FIG. 10 storage media 1006 is depicted as within computer system 1001A, in some embodiments, storage media 1006 may be distributed within and/or across multiple internal and/or external enclosures of computing system 1001A and/or additional computing systems. Storage media 1006 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 1000 contains one or more method execution module(s) 1008. In the example of computing system 1000, computer system 1001A includes the method execution module 1008. In some embodiments, a single method execution module may be used to perform some aspects of one or more embodiments of the methods disclosed herein. In other embodiments, a plurality of method execution modules may be used to perform some aspects of methods herein.

It should be appreciated that computing system 1000 is merely one example of a computing system, and that computing system 1000 may have more or fewer components than shown, may combine additional components not depicted in the example embodiment of FIG. 10, and/or computing system 1000 may have a different configuration or arrangement of the components depicted in FIG. 10. The various components shown in FIG. 10 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 1000, FIG. 10), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for discovering geofeatures in a subterranean formation, the method comprising:
receiving first input data comprising training seismic surveys;
training a model based on the training seismic surveys to produce a pre-trained model using a self-supervised learning (SSL) technique;
receiving second input data comprising one or more target seismic surveys associated with the subterranean formation;
generating geological representations of the subterranean formation using the pre-trained model and based on the one or more target seismic surveys;
generating a database based on the geological representations; and
generating an output based on the database.

2. The method of claim 1, further comprising receiving a geofeature query comprising one or more geofeatures of interest, wherein the output is based on the database and the geofeature query.

3. The method of claim 1, further comprising automatically identifying one or more geofeatures of interest in the database based on the geological representations, wherein identifying the one or more geofeatures of interest comprises identifying a respective type of the one or more geofeatures of interest, a respective location of the one or more geofeatures of interest, or a combination thereof; and
wherein generating the database comprises storing the respective type of the one or more geofeatures of interest, the respective location of the one or more geofeatures of interest, or a combination thereof, in the database.

4. The method of claim 1, wherein generating the database based on the geological representations comprises:
training a small model to produce an interpretation head downstream of the pre-trained model;
segmenting one or more geofeatures of interest to produce one or more extracted segments using the interpretation head and based on the geological representations; and
generating the database based on the one or more extracted segments.

5. The method of claim 1, wherein generating the geological representations comprises:
generating seismic sections based on the one or more target seismic surveys; and
generating the geological representations based on the seismic sections using the pre-trained model.

6. The method of claim 5, wherein generating the geological representations further comprises transforming the seismic sections to high-dimensional vectors using the pre-trained model, and
wherein generating the database comprises plotting the high-dimensional vectors in a multi-dimensional domain of the database.

7. The method of claim 6, wherein each of the high-dimensional vectors comprises a respective semantic meaning, and wherein generating the database further comprises clustering each of the high-dimensional vectors in the multi-dimensional domain based on the respective semantic meaning.

8. The method of claim 1, wherein the model is a Vision Transformer (ViT) model, wherein the pre-trained model is a large foundation model, wherein the SSL technique is based on one or more knowledge-distillation techniques.

9. The method of claim 1, wherein training the model based on the training seismic surveys comprises:
augmenting the training seismic surveys to generate augmented global views and augmented local views using data augmentation techniques of the SSL technique;
producing teacher representation/embeddings with a teacher network of the SSL technique based on the augmented global views;
producing student representation/embeddings with a student network of the SSL technique based on the augmented local views;
determining student weights of the student network based on the student embeddings and the teacher embeddings;
determining teacher weights of the teacher network based on the student weights; and
producing the pre-trained model based on the teacher weights.

10. The method of claim 1, further comprising:
displaying the output from the database; and
performing an action in response to displaying the output;
wherein the action comprises generating or transmitting a signal that recommends, instructs, or causes a physical action to occur, wherein the physical action comprises one or more of optimizing a trajectory of a wellbore drilling operation, conducting drilling operations, conducting an exploratory operation, utilizing a single-upscaled permeability model in a simulation model, designing a production strategy, designing a hydraulic fracturing strategy, conducting risk assessments, or any combination thereof.

11. A computing system, comprising:
one or more processors; and
a memory system comprising one or more non-transitory computer-readable media storing instructions that, when executed by at least one of the one or more processors, cause the computing system to perform operations for discovering geofeatures in a subterranean formation, the operations comprising:
receiving first input data comprising training seismic surveys, wherein the training seismic surveys comprise one or more examples of the geofeatures;
training a model based on the training seismic surveys to produce a pre-trained model using a self-supervised learning (SSL) technique, wherein the model is a Vision Transformer (ViT) model, and wherein the SSL technique comprises a self-distillation with no labels technique;
receiving second input data comprising one or more target seismic surveys associated with the subterranean formation;
generating geological representations of the subterranean formation using the pre-trained model and based on the one or more target seismic surveys, wherein generating the geological representations comprises:
generating seismic sections based on the one or more target seismic surveys; and
generating the geological representations based on the seismic sections using the pre-trained model;
generating a database based on the geological representations; and
generating an output based on the database.

12. The computing system of claim 11, further comprising receiving a geofeature query comprising one or more geofeatures of interest; and
wherein generating the output comprises identifying the one or more geofeatures of interest in the database based on the geofeature query.

13. The computing system of claim 11, further comprising automatically identifying one or more geofeatures of interest in the database based on the geological representations, wherein identifying the one or more geofeatures of interest comprises identifying a respective type of the one or more geofeatures of interest, a respective location of the one or more geofeatures of interest, or a combination thereof; and
wherein generating the database comprises storing the respective type of the one or more geofeatures of interest, the respective location of the one or more geofeatures of interest, or a combination thereof, in the database.

14. The computing system of claim 11, wherein generating the database based on the geological representations comprises:
training a small model to produce an interpretation head downstream of the pre-trained model, wherein the small model is a convolutional neural network;
segmenting one or more geofeatures of interest to produce one or more extracted segments using the interpretation head and based on the geological representations; and
generating the database based on the one or more extracted segments.

15. The computing system of claim 14, wherein the small model is trained with labeled training datasets.

16. A non-transitory computer-readable medium storing instructions that, when executed by one or more processors of a computing system, cause the computing system to perform operations for discovering geofeatures in a subterranean formation, the operations comprising:
receiving first input data comprising training seismic surveys, wherein the training seismic surveys comprise one or more examples of the geofeatures, and wherein the training seismic surveys do not comprise one or more labels, ground-truth annotations, or a combination thereof;
training a model based on the training seismic surveys to produce a pre-trained model using a self-supervised learning (SSL) technique, wherein the model is a Vision Transformer (ViT) model, wherein the SSL technique comprises a self-distillation with no labels technique, and wherein the pre-trained model is a large foundation model;
receiving second input data comprising one or more target seismic surveys associated with the subterranean formation;
generating geological representations using the pre-trained model and based on the one or more target seismic surveys, wherein generating the geological representations comprises:
generating seismic sections based on the one or more target seismic surveys; and
transforming the seismic sections to the geological representations using the pre-trained model, wherein the geological representations are high-dimensional vectors;
generating a database based on the geological representations; and
generating an output based on the database.

17. The non-transitory computer-readable medium of claim 16, further comprising receiving a geofeature query comprising one or more geofeatures of interest, wherein the geofeature query comprises one or more of an image of the geofeature of interest, text of the geofeature of interest, or a combination thereof; and
wherein generating the output comprises identifying the one or more geofeatures of interest in the database based on the geofeature query using one or more analogs, a semantic similarity search, or a combination thereof.

18. The non-transitory computer-readable medium of claim 16, further comprising automatically identifying one or more geofeatures of interest in the database based on the geological representations, wherein identifying the one or more geofeatures of interest comprises identifying a respective type and a respective location of the one or more geofeatures of interest; and
wherein generating the database comprises storing the respective type and the respective location of the one or more geofeatures of interest in the database.

19. The non-transitory computer-readable medium of claim 16, wherein generating the database based on the geological representations comprises:
training a small model to produce an interpretation head downstream of the pre-trained model, wherein the small model is a convolutional neural network, wherein the small model is trained with labeled training datasets, and wherein training the small model comprises a stochastic gradient descent mechanism; and
segmenting one or more geofeatures of interest using the interpretation head and based on the geological representations, wherein segmenting the one or more geofeatures of interest comprises:
receiving the high-dimensional vectors at the interpretation head; and
extracting one or more segments of the geofeatures of interest using the interpretation head to produce one or more extracted segments; and
generating the database based on the one or more extracted segments.

20. The non-transitory computer-readable medium of claim 19, wherein generating the database further comprises:
generating segmentation masks using the interpretation head and based on the one or more extracted segments; and
generating the output based on the segmentation masks.
